(19) United States
(12) Patent Application Publication
(10) Pub. No.: US 2004/0205520 A1
(43) Pub. Date: Oct. 14, 2004

(54) System and method for introducing programming constructs into computer intelligible electronic data

(75) Inventors: Steven E. Adams, Dublin, OH (US); James R. Davee, Clayton, OH (US); Steven R. Zimmerman, Columbus, OH (US); Fouzia Kiani, Grove City, OH (US)

Correspondence Address: William B. Nash, JACKSON WALKER L.L.P., Suite 2100, 112 E. Pecan Street, San Antonio, TX, 78205, US

(73) Assignee: EC Outlook, Inc.

(21) Appl. No.: 10/028,136

(22) Filed: Dec. 20, 2001

(51) Int. Cl. G06F 15/00; G06F 17/24

(52) U.S. Cl. 715/503; 715/513

(57) ABSTRACT

The present invention provides a system and method of embedding commands into electronic data utilizing canonical XML. The embedded commands are designed using a strict canonical XML format so as to be fully compliant with W3C XML standards. The resulting XML data is capable of holding both data and program coding without the introduction of non-compliant markup language elements. The present invention allows XML data containing embedded code to be subsequently parsed, utilized, and/or mined by XML-compliant applications, utilities, and tools.

### FIELD OF THE INVENTION

The present invention relates generally to a system and method of introducing programming constructs into electronic data and, more particularly, to a system and method of embedding and executing commands within electronic data utilizing a markup language.

### BACKGROUND OF THE INVENTION

A markup language is used to identify structures present within electronic data. Extensible Markup Language (XML) is a markup language having a standardized format capable of describing structured data. “Structured data” may include electronic data including, but not limited to, purchase orders, spreadsheets, address books, configuration parameters, financial transactions and technical drawings. Programs capable of producing structured data typically store the data upon a computer readable medium using a text format. Storage of the data utilizing a text format allows the user, if necessary, to look at the data without the assistance of the program(s) that produced the data.

XML provides a set of standardized rules, guidelines and/or conventions for designing text formats for structured data. Typically, electronic data utilizing XML is easy to read, unambiguous, and avoid common pitfalls such as the lack of extensibility, lack of support for internationalization/localization, and platform-dependency.

XML is extensible in that it is not a fixed format. Unlike HTML, which is best described as a single, predefined markup language, XML is actually a “metalanguage” capable of describing other languages. This feature of XML allows the user to design customized markup languages for a variety of document types.

As a standardized format defined by the World Wide Web Consortium (W3C), XML demands strict adherence to specific structure and formatting rules in order to maintain full compatibility with other XML-compliant applications. There are many XML utilities and tools available worldwide, none of which will work with proprietary XML variants.

XML is an excellent tool for managing the transport of data. The inherent tagging system of XML denotes specific fields of information that can be exploited to load XML data into other applications for additional processing.

Missing in XML, however, is the ability to manipulate or programmatically manage XML data using commands stored within the XML itself. Prior attempts to introduce programmatic control over XML data have produced proprietary XML formats. While proprietary formats offer the desired XML programming functions, they do so in a manner that invalidates the XML data for the W3C standards, making XML tools and utilities useless.

There remains a need for a system and method capable of establishing and embedding programming constructs within XML compliant electronic data without violating W3C standards.

### SUMMARY OF THE INVENTION

The present invention provides a system and method of embedding programmatic code into electronic data utilizing canonical XML. The embedded code is designed using a strict canonical XML format so as to be fully compliant with W3C XML standards. Thus, the resulting XML data is capable of holding both data and program coding without the introduction of non-compliant markup language elements. The present invention allows XML data containing embedded code to be subsequently parsed, utilized, and/or mined by XML-compliant applications, utilities, and tools.

The present invention provides a processing engine capable of reading XML data containing embedded code and executing command instructions contained therein. The processing engine of the present invention is capable of performing command instructions upon code and data residing within the electronic data source or upon external code and data accessible to the processing engine. The processing engine of the present invention is capable of accessing and utilizing external applications or systems for use in executing command instructions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a process flow diagram illustrating the introduction and execution of commands in one embodiment of the present invention.

FIG. 2 is an illustration of XML data that does not utilize a namespace.

FIG. 3 is an illustration of XML data having commands embedded within a namespace.

FIG. 4 is a process flow diagram illustrating the command creation process of one embodiment of the present invention.

FIG. 5 is a process flow diagram illustrating the command execution process of one embodiment of the present invention.

FIG. 6 is a process flow diagram illustrating the command modification process of one embodiment of the present invention.

### DETAILED DESCRIPTION OF THE INVENTION

The present invention is herein described as a method of introducing programming constructs into computer intelligible electronic data (18), as a computer readable medium comprising a plurality of instructions for introducing programming constructs into computer intelligible electronic data and as a computer system for introducing programming constructs into computer intelligible electronic data.

Referring to the Figures, the present invention is capable of embedding commands (20) within one or more sets of electronic data (18) to create FXML data (24) capable of holding both data (26) and programmatic commands (20) without the introduction of non-compliant markup language elements. In one embodiment, FXML data may comprise an electronic data file, a computer application, or any data stream or data collection containing both incoming data (18) and embedded programmatic commands (20). The commands (20) utilized by the present invention are designed to utilize a markup language compatible with the incoming data (18). As discussed further below, the present invention allows one or more commands (20) to be embedded within the incoming data in a manner that allows the resulting FXML data (24) to be accessed and processed by a wide variety of tools and/or systems. In one embodiment, the FXML data (24) of the present invention may be accessed and processed by a W3C standards based tool.

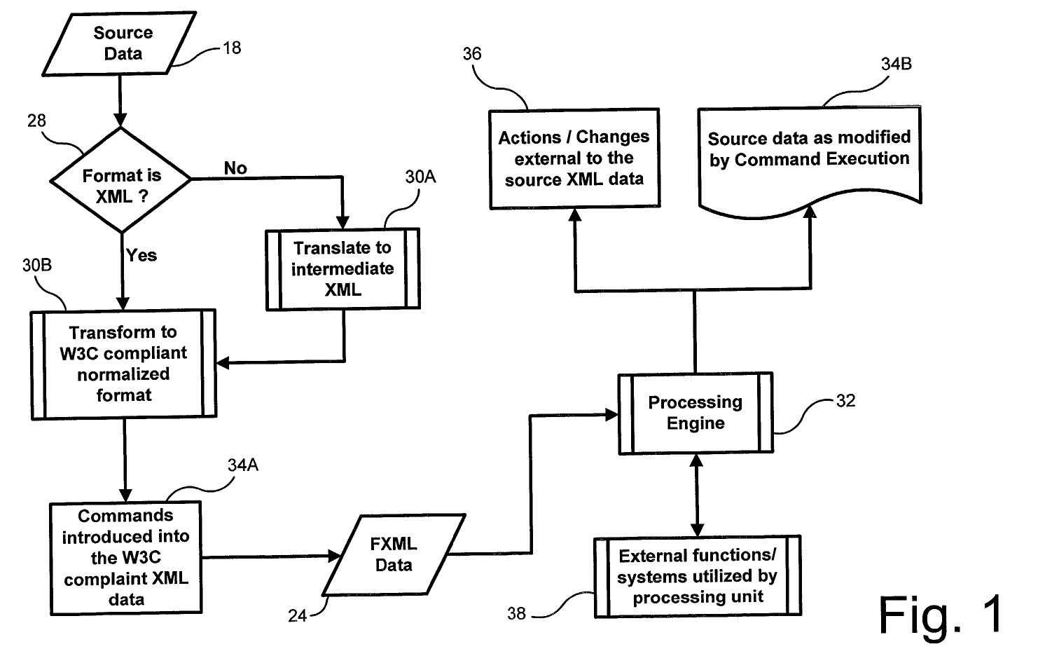

Referring to FIG. 1, incoming data (18) is accessed by the processing unit (12) of the present invention to determine the markup language utilized by the incoming data, as illustrated by Box (28). In one embodiment, the present invention utilizes canonical, W3C compliant, extensible markup language (XML). If the incoming data (18) does not utilize canonical W3C compliant XML, the incoming data is translated to an intermediate XML format, as illustrated by Box (30A). Once translated into intermediate XML format, the incoming data (18) is transformed into normalized, W3C compliant, XML format as illustrated by Box (30B). The translation/transformation process may be performed by any number of known systems (not shown).

In one embodiment, each command (20) is designed to be XML compliant. Accordingly, once the incoming data (18) has been converted to normalized XML, one or more commands (20) may be introduced into the incoming data, as illustrated by Box (34A). The resulting FXML data (24) may then be read and/or processed by any XML compliant tool and/or application without failure. Specifically, by embedding XML compliant commands (20) within the incoming data (18), the present invention allows the data and the commands to “travel together”. This feature of the present invention allows the user to prepare commands (20) for use with specific types of incoming data (18), thus greatly enhancing data processing and analysis. For example, the user may prepare data processing commands (20) for introduction into electronic data (18), such as a purchase order, to ensure that the unit price listed on the purchase order is within a certain margin of acceptability, as illustrated by Box (34B).

The present invention is highly versatile and may be used with a variety of hardware platforms. For example, the present invention may be used with a host of personal computers and mid-range computer platforms (not shown). Platform specific code may be generated for Windows, Solaris, Linux, Hewlett Packard HP-UX, and Palm OS operating systems, if desired.

In one embodiment of the present invention, canonical XML data formats are utilized. As a result, all data media that supports or enables the storage of XML data (26) may be utilized by the present invention. Any media type or environment supported by the operating system and hardware platform, whether local to the system or over a network, may be used to store FXML data (24) utilized by the present invention. For example, direct access storage devices (DASD), write-once read-many devices (WORM), directly accessible tape and solid state devices (SSD), single or multiple read/write head, redundant array (RAID of any level), or jukebox subsystems may be utilized by the present invention. The present invention is capable of efficient operation without the use of proprietary media formats, hidden partitions, or any other storage media preparation in addition to that required and/or supported by the operating system and hardware platform on which the present invention is installed.

The commands (20) utilized by the present invention are designed to “blend into” the incoming data (18) in order to allow any XML compliant system to access and process the data residing therein. Typically, XML compliant tools/systems are designed to process the data (26) residing within incoming data (18), not to execute embedded commands (20). Accordingly, in one embodiment, the present invention provides a processing engine (32) capable of executing embedded commands (20) within the FXML data (24). Specifically, the processing engine (32) is designed to differentiate between individual data elements (26) and commands (20) so that the commands may be acted upon. Thus, non-command data elements within the FXML data (24) become immediately available as values for use as directed by the commands (20) residing within the FXML data.

In one embodiment, the processing engine (32) of the present invention is capable of parsing commands (20) from within the FXML data (24) and executing same. Additionally, the processing engine (32) of the present invention is capable of executing complex processes, making detailed decisions, and modifying data (26) as directed by one or more commands (20). If one or more commands (20) direct the processing engine (32) to act upon data (26) within newly created FXML data (24), the processing engine identifies the XML data to be acted upon through the use of an XML tagging process, as illustrated by Box (34A). The XML tagging process utilized by the present invention is described in detail below.

The processing engine (32) is not restricted to execution of commands upon the newly created FXML data (24) within which the commands (20) are embedded. If directed by one or more commands (20), the processing engine (32) is capable of acting upon data other than the immediate FXML data (24), as illustrated by Box (36). Additionally, the processing engine (32) is capable of utilizing external functions and/or systems to execute command directives. For example, if one or more commands embedded within the FXML data (24) directs the processing engine (32) to perform a spreadsheet analysis of the FXML data, the processing engine of the present invention is capable of accessing an external spreadsheet application, such as MICROSOFT EXCEL®, to accomplish the command directive, as illustrated by Box (38). The ability of the processing engine (32) of the present invention to load and call external routines, procedures and/or functions allows processing unit (12) resources to be directed to command execution and management of required parameters and/or external values. Specifically, by designing the processing engine (32) to interact with and utilize external systems, the efficiency of the present invention is greatly enhanced.

The relationship between the commands (20) and the processing engine (32) is defined by a set of command functions having required parameters, as described further below. In one embodiment of the present invention, one or more commands (20) are equipped with governors capable of limiting the number of times a command loop may be executed as well as the number of times a command routine can be called recursively.

In one embodiment of the present invention, the processing engine (32) is a sophisticated compiler. In one embodiment, the processing engine (32) utilizes known optimization techniques to enhance efficiency. One such technique takes the command instructions and performs a transformation in the same language, such that the resulting command program is smaller and faster to process than the original and remains functionally identical. This technique is especially useful in the command (20) generation process where the user is entering command preferences. In one embodiment, command preferences may be entered through a user interface (16). In another embodiment, syntactic enhancements are utilized to make the commands (20) easier for the user to understand. To illustrate, the following example is provided.

Traditional expression:

a+a+a+a+a

Generated commands:

<add value=“a a” result=“Temp--A”/>
<add value=“Temp--A a” result=“Temp--B”/>
<add value=“Temp--B a” result=“Temp--C”/>
<add value=“Temp--C a” result=“Final”/>

Optimized commands:

<mul value=“a 5” result=“Final”/>

In another embodiment of the present invention, the processing engine (32) utilizes a constant folding optimization technique. Specifically, a compiler optimization is utilized to simplify the handling of constant values as opposed to variables. To illustrate, the following example is provided.

Traditional expression:

1*(2+3)*4

Generated commands:

<add value=“2 3” result=“Temp--A”/>
<mul value=“1 Temp--A” result=“Temp--B”/>
<mul value=“Temp--B 4” result=“Final”/>

Optimized commands:

<set var=“Final” value=“20”/>

In another embodiment of the present invention, the processing engine (32) utilizes subexpression elimination. Specifically, common subexpressions are computed one time and the result is saved in an intermediate variable instead of doing the computation each time. The following example illustrates common subexpression elimination as well as the use of a two-tiered result stack.

Traditional expression:

(a+1)*b+(a+1)*c

Generated commands:

<add value=“a 1” result=“Temp--A”/>
<mul value=“Temp--A b” result=“Temp--B”/>
<add value=“a 1” result=“Temp--C”/>
<mul value=“Temp--C c” result=“Temp--D”/>
<add value=“Temp--D Temp--B”/>

Optimized commands:

<add value=“a 1”/>
<mul value=“b @result”/>
<mul value=“c @prevresult”/>
<add value=“@result @prevresult”/>

In another embodiment of the present invention, the processing engine utilizes profiling features. Specifically, each step in a chain of commands is timed for duration. By utilizing profiling features, the processing engine (32) is capable of providing the execution path for the FXML data (24) at issue for use as a logging function. In instances where the processing engine (32) utilizes external functions/systems, the processing engine is capable of importing profiling data into the host environment's logging data storage for subsequent use. In another embodiment of the present invention, the processing engine (32) is capable of “just-in-time” compiling. Specifically, a portion of the command operations are converted to machine code at the time of compiling for subsequent use.

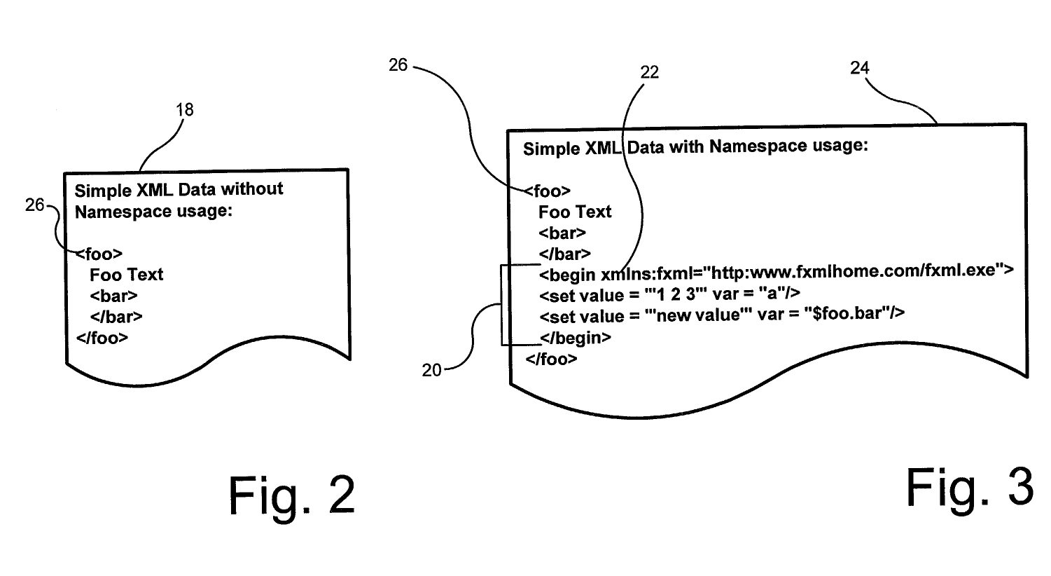

Referring to FIGS. 2 and 3, in one embodiment of the present invention, commands (20) are designed for insertion as XML namespaces (22). The use of XML namespaces (22) for insertion of XML compliant commands provides the present invention with several distinct advantages.

FXML data (24) containing data (26) and commands (20) may be stored within a storage device (14) for data mining activities. Specifically, embedding XML compliant commands within XML namespaces (22) allows resulting FXML data (24) to be easily mined. This feature of the present invention allows mining of stored FXML data (24) using any XML compliant tool or application. Thus, the present invention allows the examination of both the data (26) and the commands (20) within the FXML data to determine what actions have been taken upon the data (26) within the FXML data and for what purpose such actions where taken.

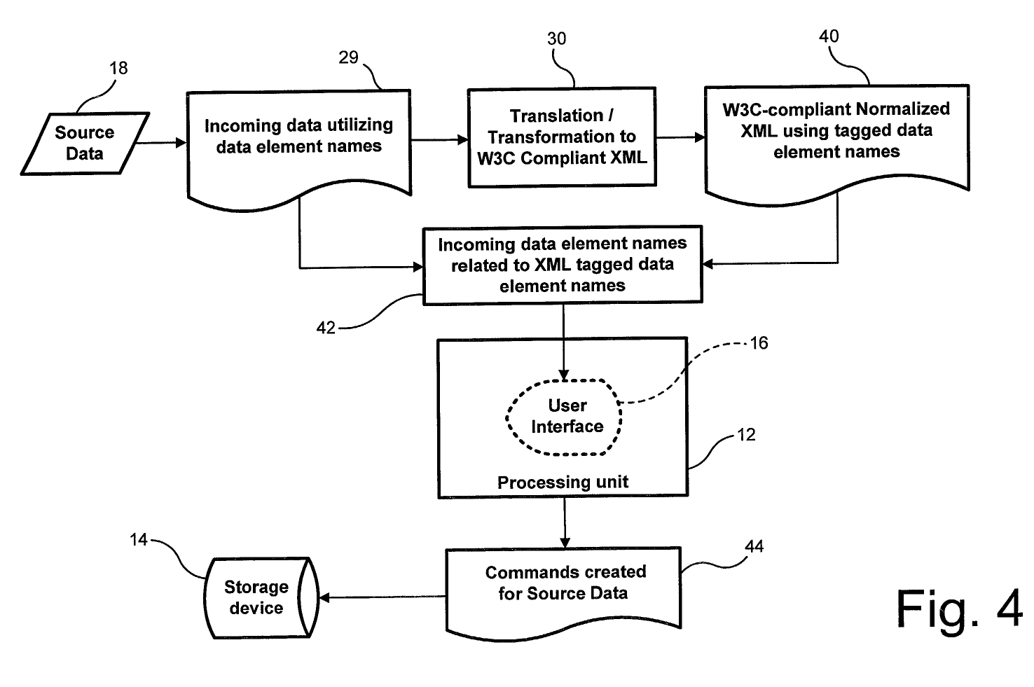

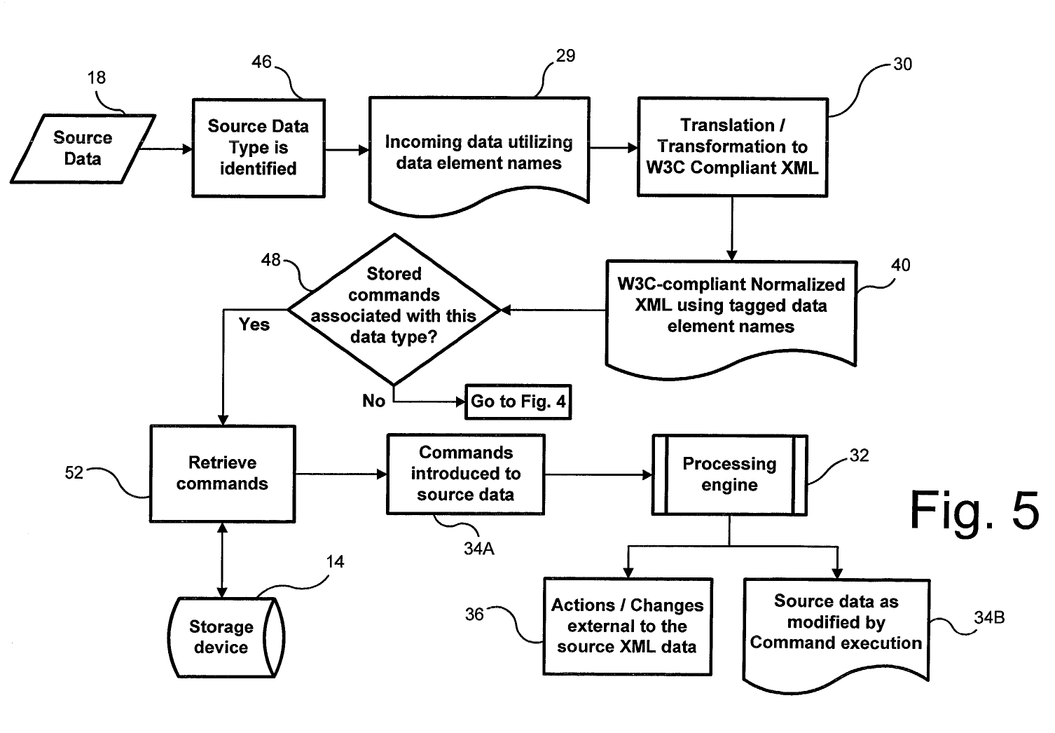

Referring to FIG. 4, incoming data (18) or a sample thereof, as illustrated by Box (29), may be accessed to determine its type. Once the incoming data's type has been determined, the incoming data may be translated and transformed into W3C compliant XML format, if necessary, as illustrated by Box (30). In one embodiment, translation parameters specific to the incoming data's (18) format are expressed as an XSLT document and retained in the storage device (14) for subsequent translation/transformation of similar incoming data.

In another embodiment, a library (not shown) containing predefined, W3C compliant, tagged data element names is provided, as illustrated by Box (40). The library of tagged data element names may be used to represent the data element names present within incoming data to allow incoming data (18) or a sample thereof to be internally represented within the processing unit (12) in W3C compliant XML format, as illustrated by Box (42). Additionally, this feature of the present invention allows an external user to view the original data element names through a user interface (16) if desired, while allowing the processing unit (12) to deal with W3C compliant tagged data elements only.

Referring to Box (44) of FIG. 4, commands may be created by the processing unit (12) through analysis and transformation of incoming data (18) or a sample thereof. Alternatively, an external user may enter command preferences through a user interface (16). These command preferences may then be used by the processing unit (12) of the present invention to prepare XML compliant commands. In one embodiment, commands (20) created by the processing unit (12) may be immediately embedded into incoming data (18) or stored within the storage device (14). Stored commands (20) are identified by the processing unit (12) of the present invention as being associated with incoming data (18) and/or a particular data type. Accordingly, commands identified as being associated with subsequently accessed data may be executed and/or embedded within subsequently accessed data having a predefined type.

In one embodiment, complex operations are expressed in terms of XML compliant commands (20) instead of embedded expressions to facilitate the use of data mining tools, as described above. In another embodiment, simple Boolean expressions are supported within conditional attributes, thus eliminating the need for parsers to understand arbitrarily complex programmatic expressions.

Commands (20) utilized by the present invention may be constructed using non-explicit type declarations. In one embodiment, the usage of non-explicit type declarations is limited to variables and constants such that the processing engine (32) of the present invention may readily convert between various types, if required.

Commands (20) utilized by the present invention are designed to be easily generated by other tools, such as those with which a user may enter data processing rules in a language/format other than XML. The user's data processing rules would then be translated to XML compliant commands (20) for use at runtime. This feature of the present invention greatly simplifies the mining algorithms from the commands themselves.

As discussed above, the present invention introduces known programming concepts into the standard canonical XML format. In one embodiment, commands (20) are designed to support local and global variables. In another embodiment, the commands (20) of the present invention support alternation to allow decision tree branching, and looping to allow defined iterations during command execution. The use of known programming constructs allows the operation of complex commands and application, if required. In another embodiment, the commands of the present invention are capable of utilizing native operating system commands.

In one embodiment, blocking or grouping commands may also be utilized by the present invention to provide for the nesting of electronic data. In another embodiment, the commands (20) of the present invention utilize call by name. To illustrate, at the point and time of invocation, the processing unit (12) of the present invention evaluates the name of the called routine using standard variable lookup rules. In one embodiment, the name of the called routine may be a literal name, a string capable of naming the routine, or a variable capable of holding the name of the routine to call.

In another embodiment, commands (20) utilize iterators. To illustrate, a user-defined routine may be called, passing in all values, or a subset of values, from a variable. While any variable may be used for this purpose, XML variables are typically utilized. In this case, the XML variable name and value may be passed into the indicated routine by the present invention.

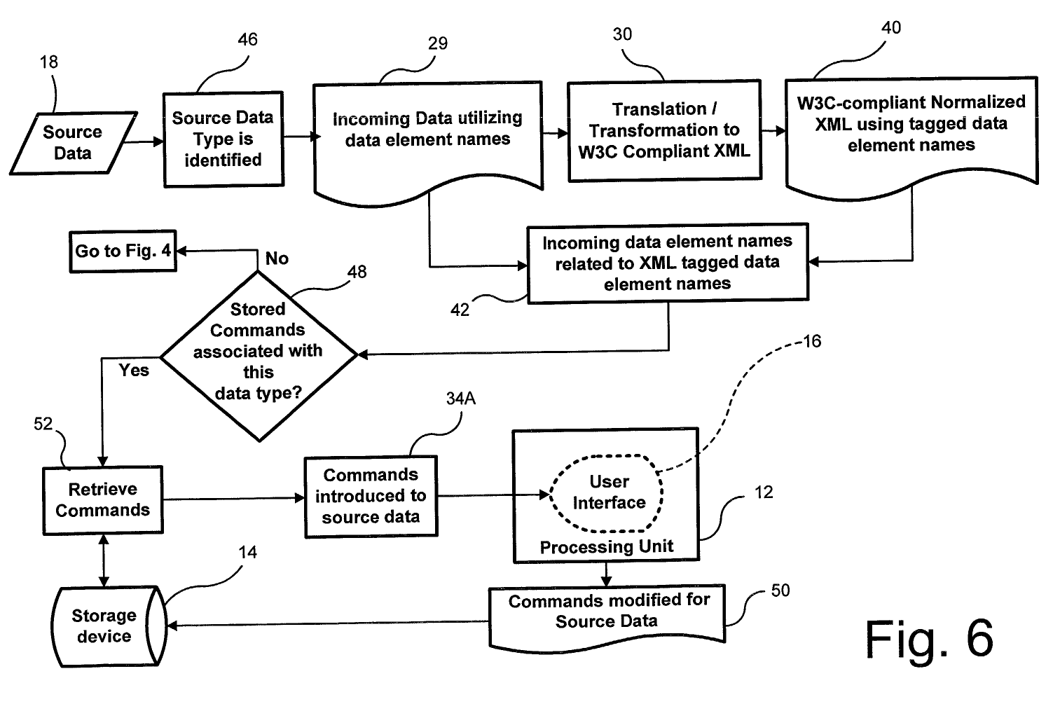

Referring to FIG. 5, the processing engine (32) of the present invention is capable of executing newly created commands (20) or pre-existing commands held upon the storage device (14). In one embodiment, the type of incoming or source data (18) is identified as illustrated by Box (46). Once the type has been identified, the processing unit (12) of the present invention determines if one or more pre-existing commands (20) associated with the data type exist, as illustrated by Box (48). If pre-existing commands (20) exist for this data type, the processing unit (12) of the present invention retrieves the commands from the storage device (14), as illustrated by Box (52). Retrieved commands may then be routed to the processing engine (32) for execution as described in detail above.

Referring to FIG. 6, the processing unit (12) of the present invention is capable of modifying newly created commands (20) or pre-existing commands. In one embodiment, the data type associated with an incoming data (18) is identified, as illustrated by Box (46). Once the type has been identified, the processing unit (12) of the present invention determines if one or more pre-existing commands (20) associated with the data type exist, as illustrated by Box (48). If pre-existing commands exist for this data type, the processing unit (12) of the present invention retrieves the commands (20) from the storage device (14) as illustrated by Box (52). Once retrieved, the processing unit (12) of the present invention allows the user to input modification preferences through the user interface (16). The data element naming convention utilized by the present invention, as described above, allows an external user to view data (26) utilizing the original data element names, as illustrated by Box (42), while allowing the processing unit (12) to deal with commands (20) in W3C compliant XML format. The processing unit (12) of the present invention may then modify the commands according to user modification preferences, as illustrated by Box (50).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A method of introducing programming constructs into computer intelligible electronic data comprising the steps of:
accessing a first set of said electronic data, said first set of said electronic data containing data elements and utilizing a markup language;
establishing one or more commands compatible with said markup language; and
embedding one or more of said commands within at least a portion of said first set of said electronic data.

2. The method of claim 1, further comprising the step of:
creating FXML data containing said data elements and said commands.

3. The method of claim 2, further comprising the step of: storing said FXML data within a storage device.

4. The method of claim 1, further comprising the step of
if said markup language utilized by said commands is not extensible markup language, converting one or more of said commands into extensible markup language.

5. The method of claim 4, further comprising the step of:
embedding one or more of said commands into one or more namespaces.

6. The method of claim 2, further comprising the step of:
providing a processing engine compatible with said markup language;
utilizing said processing engine, reading said FXML data;
identifying said commands embedded within said FXML data; and
executing one or more of said commands.

7. The method of claim 1, further comprising the step of:
providing a user interface through which a user may enter one or more command preferences.

8. The method of claim 2, further comprising the step of:
mining said data elements and said commands within said FXML data.

9. A computer readable medium comprising a plurality of instructions for introducing programming constructs into computer intelligible electronic data which, when read by a computer system, causes the computer to perform the steps of:
accessing a first set of said electronic data, said first set of said electronic data containing data elements and utilizing a markup language;
establishing one or more commands compatible with said markup language; and
embedding one or more of said commands within at least a portion of said first set of said electronic data.

10. The medium of claim 9, further comprising the step of:
creating FXML data containing said data elements and said commands.

11. The medium of claim 10, further comprising the step of:
storing said FXML data within a storage device.

12. The medium of claim 9, further comprising the step of
if said markup language utilized by said commands is not extensible markup language, converting one or more of said commands into extensible markup language.

13. The medium of claim 12, further comprising the step of:
embedding one or more of said commands into one or more namespaces.

14. The medium of claim 10, further comprising the step of:
providing a processing engine compatible with said markup language;
utilizing said processing engine, reading said FXML data;
identifying said commands embedded within said FXML data; and
executing one or more of said commands.

15. The medium of claim 9, further comprising the step of:
providing a user interface through which a user may enter one or more command preferences.

16. The medium of claim 10, further comprising the step of:
mining said data elements and said commands within said FXML data.

17. A computer system for introducing programming constructs into computer intelligible electronic data comprising:
a processing unit capable of accessing a first set of said electronic data, said first set of said electronic data containing data elements and utilizing a markup language, said processing unit being further capable of establishing one or more commands compatible with said markup language and embedding one or more of said commands within at least a portion of said first set of said electronic data.

18. The computer system of claim 17, wherein said processing unit is further defined as being capable of creating FXML data containing said data elements and said commands.

19. The computer system of claim 18, further comprising a storage device coupled to said processing unit, said processing unit capable of storing said FXML data within said storage device.

20. The computer system of claim 17, wherein said processing unit is further defined as being capable of converting one or more of said commands into extensible markup language.

21. The computer system of claim 20, wherein said processing unit is further defined as being capable of embedding one or more of said commands into one or more namespaces.

22. The computer system of claim 18, further comprising a processing engine capable of reading said FXML data, identifying said commands embedded within said FXML data and executing one or more of said commands.

23. The computer system of claim 17, wherein said processing unit is further defined as being capable of receiving one or more command preferences through a user interface, said user interface coupled to said processing unit.

24. The computer system of claim 17, wherein said commands comprise executable programmatic commands.

25. The computer system of claim 17, wherein said commands comprise data processing rules.

26. The computer system of claim 22, wherein said commands are capable of directing said processing engine to access external source data.

27. The computer system of claim 22, wherein said commands are capable of directing said processing engine to utilize one or more external systems.

28. The computer system of claim 18, wherein said processing unit is further defined as being capable of mining said data elements and said commands within said FXML data.
